(19) United States
(12) Patent Application Publication
(10) Pub. No.: US 2020/0142398 A1
(43) Pub. Date: May 7, 2020

(54) METHOD, DEVICE AND SYSTEM FOR CONTROLLING UNMANNED AERIAL VEHICLE, AND STORAGE MEDIUM

(71) Applicant: SZ DJI TECHNOLOGY CO., LTD., Shenzhen (CN)

(72) Inventor: Lijian LIU, Shenzhen (CN)

(21) Appl. No.: 16/726,533

(22) Filed: Dec. 24, 2019

Related U.S. Application Data
(63) Continuation of application No. PCT/CN2017/090553, filed on Jun. 28, 2017.

(51) Int. Cl. G05D 1/00; H04N 5/232; G05D 1/10; B64C 39/02; B64D 47/08

(52) U.S. Cl. CPC G05D 1/0016; H04N 5/23216; H04N 5/23203; B64C 2201/141; B64C 39/024; B64D 47/08; B64C 2201/146; G05D 1/101

(57) ABSTRACT

The present disclosure provides an unmanned aerial vehicle (UAV) control method. The method includes acquiring a predetermined trajectory using a controller; and converting the predetermined trajectory into a first flight parameter using the controller and transmitting the first flight parameter to a first UAV. The first UAV is configured to fly based on the first flight parameter to generate a first flight trajectory.

### CROSS-REFERENCE TO RELATED APPLICATION

This application is a continuation of International Application No. PCT/CN2017/090553, filed on Jun. 28, 2017, the entire content of which is incorporated herein by reference.

### TECHNICAL FIELD

The present disclosure relates to the field of flight technology, and more specifically, to a method, device, system and storage medium for controlling an unmanned aerial vehicle (UAV).

### BACKGROUND

In the field of flight technology, when a user controls the UAV in flight at a control terminal on the ground, the user generally controls the flight direction, flight speed, or flight attitude of UAV manually. Alternatively, a flight trajectory of the UAV can be planned in advance at the control terminal, then the flight task information indicating the flight trajectory can be transmitted to the UAV, such that the UAV can automatically fly based on the received flight task information.

However, in order to ensure that the UAV can automatically fly based on the set flight trajectory, detailed and complicated flight task information may need to be set when the user sets the flight task information on the control terminal. For example, global positioning system (GPS) information of each coordinate on the flight trajectory may need to be set in order to implement an aerial photography task. In particular, when the flight trajectory of the automatic flight is complicated or farther, complex GPS sequence information may need to be set. Moreover, if it is necessary to consider external factors such as obstacles and wind speed of the flight environment, the GPS sequence information that needs to be set may be even more complex. As such, setting an automatic flight is a complicated task, and may require professional help and take more time.

### SUMMARY

One aspect of the present disclosure provides an unmanned aerial vehicle (UAV) control method. The method includes acquiring a predetermined trajectory using a controller; and converting the predetermined trajectory into a first flight parameter using the controller and transmitting the first flight parameter to a first UAV. The first UAV is configured to fly based on the first flight parameter to generate a first flight trajectory.

Another aspect of the present disclosure provides a UAV control method. The method includes receiving a first flight parameter transmitted from a controller at a UAV, the first flight parameter corresponding to a predetermined trajectory; and controlling the UAV to fly based on the first flight parameter to generate a first flight trajectory.

Another aspect of the present disclosure provides an imaging device control method. The method includes receiving an imaging parameter from a controller for configuring the imaging device; and capturing, according to the imaging parameter, a first flight trajectory of a first UAV flying based on a first flight parameter, the first flight parameter being correspond to a predetermined trajectory.

In the embodiment of the present disclosure, after the controller acquires the predetermined trajectory, the predetermined trajectory is converted into the first flight parameter, which is transmitted to the first UAV, such that the first UAV can fly based on the first flight parameter to generate the first flight trajectory. It can be seen that since the first flight parameter is acquired based on the predetermined trajectory of the first UAV, it is not necessary to set the flight trajectory of the first UAV by setting the coordinates of each trajectory point to realize the flight parameter acquisition method of the present disclosure, thereby reducing the complexity of setting the flight trajectory.

### BRIEF DESCRIPTION OF THE DRAWINGS

FIG. 1 is a diagram illustrating a network topology of a UAV system according to an embodiment of the present disclosure.

FIG. 2 is a diagram illustrating another network topology of the UAV system according to an embodiment of the present disclosure.

FIG. 3 is a flowchart illustrating a UAV control method according to an embodiment of the present disclosure.

FIG. 4 is a diagram illustrating an interface of a controller acquiring a predetermined trajectory according to an embodiment of the present disclosure.

FIG. 5 is a diagram illustrating the predetermined trajectory according to an embodiment of the present disclosure.

FIG. 6 is another diagram illustrating the predetermined trajectory according to an embodiment of the present disclosure.

FIG. 7 is a diagram illustrating of a flight trajectory of a first UAV according to an embodiment of the present disclosure.

FIG. 8 is a flowchart illustrating the flight trajectory of a plurality of UAVs in cooperative flight according to an embodiment of the present disclosure.

FIG. 9 is another flowchart illustrating the UAV control method according to an embodiment of the present disclosure.

FIG. 10 is another diagram illustrating the predetermined trajectory according to an embodiment of the present disclosure.

FIG. 11 is another flowchart illustrating an imaging device control method according to an embodiment of the present disclosure.

FIG. 12 is a flowchart illustrating a UAV system control method according to an embodiment of the present disclosure.

FIG. 13 is a structural diagram of the controller according to an embodiment of the present disclosure.

FIG. 14 is a structural diagram of the UAV according to an embodiment of the present disclosure.

FIG. 15 is a structural diagram of the imaging device according to an embodiment of the present disclosure.

FIG. 16 is a structural diagram of the UAV system according to an embodiment of the present disclosure.

### DETAILED DESCRIPTION OF THE EMBODIMENTS

The terms “first,” “second,” or the like in the specification, claims, and the drawings of the disclosure are used to distinguish similar elements, and are not intended to illustrate a particular sequence or order. It will be appreciated that the data used this way can be interchanged when appropriate, such that the embodiments described herein can be implemented in a sequence other than what is illustrated or described herein. Furthermore, the term “including,” “comprising,” or any other variation thereof are intended to cover a non-exclusive inclusion, such that a process, a method, an article, or an apparatus that comprises a plurality of steps or modules includes not only those steps or modules but also other steps or modules that are not explicitly listed, or also includes steps or modules that are inherent to the process, the method, the article, or the apparatus. The division of modules herein is merely a logical division, and there may be other divisions when implemented in practical applications. For example, multiple modules may be combined or integrated into another system, or some features may be omitted or not implemented. Moreover, the coupling or direct coupling or communication connection between the modules shown or discussed may be the indirect coupling between the modules via some interfaces or the communication connection can be in electrical or other similar form, which is not limited herein. In addition, the modules or sub-modules described as separate components may or may not be physically separated, may or may not be physical modules, or may be distributed to multiple circuit modules, and some or all of the modules may be selected, according to the actual requirements, to accomplish the purpose of the schemes of the embodiments of the disclosure.

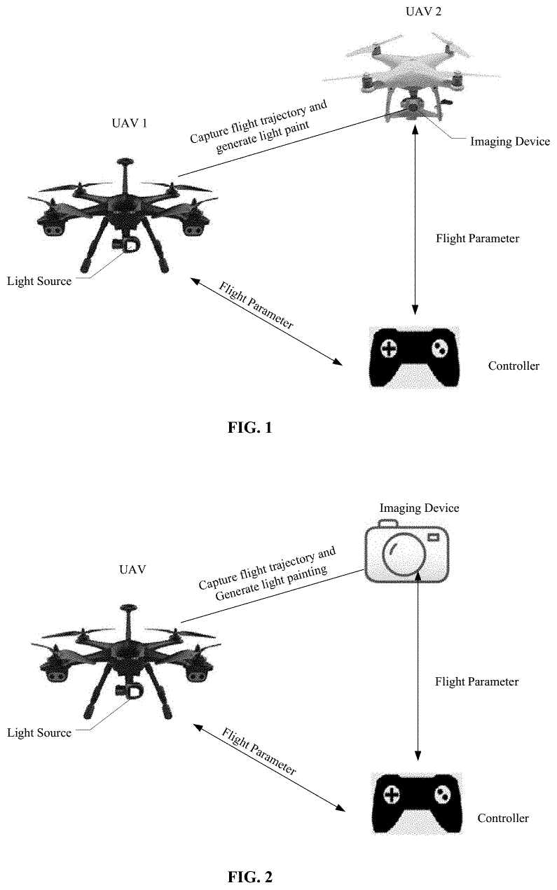

The present disclosure provides a method, device, system, and storage medium for controlling a UAV, which can be used in the field of flight control signal technology. FIG. 1 is a diagram illustrating a network topology of a UAV system according to an embodiment of the present disclosure. As shown in FIG. 1, a light source is mounted on a UAV 1, a camera is mounted on a UAV 2, and a controller is provided to configure flight parameters for the UAV 1 and the UAV 2, respectively, and transmit the flight parameters to the corresponding UAV. Subsequently, the UAV 1 may fly based on the received flight parameters, and the light source mounted thereon may also produce a corresponding trajectory. The UAV 2 may fly based on the received flight parameters, and capture the flight trajectory of the UAV 1 and form a light painting.

FIG. 2 is a diagram illustrating another network topology of the UAV system according to an embodiment of the present disclosure. As shown in FIG. 2, the light source is mounted on a UAV, and the controller may separately configure the flight parameters for the UAV and transmit the flight parameters to the UAV. Subsequently, the UAV may fly based on the received flight parameters, and the light source mounted thereon may also produce a corresponding trajectory. The camera is configured to capture the flight trajectory of the UAV and form the light painting.

It should be noted that the controller described in the embodiment of the present disclosure may be a device that provides voice and/or data connectivity to the user, a handheld device with a wireless connection function, or other processing device connected to a wireless modem. A wireless terminal can communicate with one or more core networks via a radio access network (RAN), and the wireless terminal can be a mobile terminal such as a mobile phone (or cellular phone), and a computer having a mobile terminal. A computer having a mobile terminal may be a portable, a pocket, a handheld, a computer built-in, or an in-vehicle mobile device that can exchange voice and/or data with the RAN, such as a personal communication service (PCS), a cordless phone, a session initiation protocol (SIP) phone, a wireless local loop (WLL) station, a personal digital assistant (PDA), and other devices. In some embodiments, the wireless terminal may also be referred to as a system, a subscriber unit, a subscriber station, a mobile station, a mobile, a remote station, an access point, a remote terminal, an access terminal, a user terminal, a terminal, a user agent, a user device, or a user equipment.

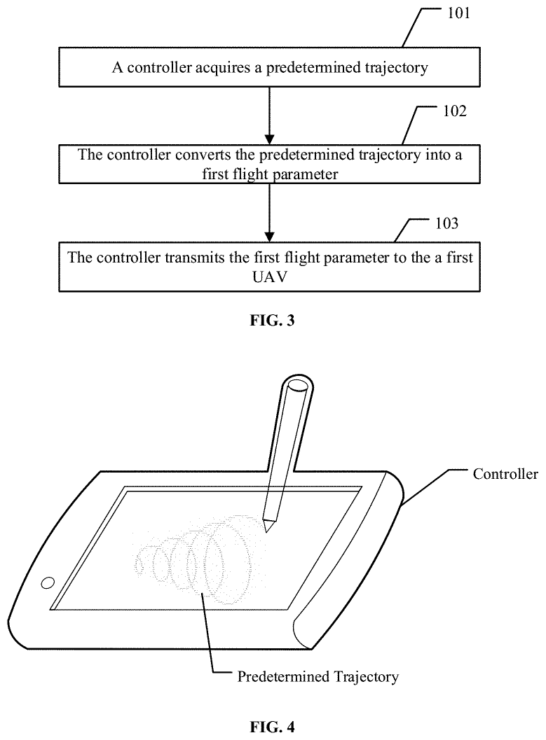

FIG. 3 is a flowchart illustrating a UAV control method according to an embodiment of the present disclosure. The UAV control method of the embodiment of the present disclosure is described from the perspective of setting a flight task and basic flight task planning using a flight controller. The UAV control method is described in detail below.

101, a controller acquires a predetermined trajectory.

The predetermined trajectory may include a plurality of trajectory points. The predetermined trajectory can be input by a user on the controller, for example, by the user may draw the predetermined trajectory in real time, or the predetermined trajectory can be imported into the controller in advance in the form of an email, a message push, etc. The specific method of acquiring the predetermined trajectory is not limited in the present disclosure. FIG. 4 is a diagram illustrating a user drawing a predetermined trajectory on a user interface of a controller.

The controller may include at least one of a remote controller, a remote controller with a display, a mobile phone, a tablet, a wristband, a watch, or a pair of flying glasses.

102, the controller converts the predetermined trajectory into a first flight parameter.

103, the controller transmits the first flight parameter to a first UAV.

The first flight parameter may be used by the first UAV to plan a flight trajectory based on the first flight parameter, and fly based on the first flight parameter and the planned flight trajectory to generate a first flight trajectory.

In the embodiment of the present disclosure, after the controller acquires the predetermined trajectory, the predetermined trajectory is converted into the first flight parameter, which is transmitted to the first UAV, such that the first UAV can fly based on the first flight parameter to generate the first flight trajectory. It can be seen that since the first flight parameter is acquired based on the predetermined trajectory of the first UAV, it is not necessary to set the flight trajectory of the first UAV by setting the coordinates of each trajectory point to realize the flight parameter acquisition method of the present disclosure, thereby reducing the complexity of setting the flight trajectory.

In some embodiments, the controller may be configured to further set a multi-dimensional coordinate system for the predetermined trajectory based on the predetermined trajectory, such as a three-dimensional coordinate system composed of an X-axis, a Y-axis, and a Z-axis as shown in FIG. 6. In some embodiments, the three-dimensional coordinate system may further include a time axis. The points in the coordinate system can be taken to correspond to the trajectory points on the predetermined trajectory.

In some embodiments, converting the predetermined trajectory into the first flight parameter using the controller may include setting a target space based on the predetermined trajectory using the controller, the predetermined trajectory is within a spatial range of the target space. Further, the controller may generate the first flight parameter based on the predetermined trajectory and the target space.

In some embodiments, the target space may be a three-dimensional body of a regular shape or a three-dimensional body of an irregular shape.

As shown in FIG. 6, the target space is shown as a cuboid as an example. The controller may set a target space capable of wrapping the predetermined trajectory based on the predetermined trajectory by setting the length, width, and height of the target space, such that the entire predetermined trajectory may be limited to the target space without setting GPS information for each trajectory point on the predetermined trajectory. The UAV control method of the present disclosure may significantly improve the trajectory planning efficiency and ensure that the UAV may generate a trajectory that coincides with all or a part of the predetermined trajectory in a given target space.

In some embodiments, generating the light painting through the first UAV can be realized based on the planning of the predetermined trajectory of the first UAV. More specifically, when the first UAV is equipped with a light source, the first flight trajectory generated by the first UAV based on the first flight parameter and the flight trajectory may be used to generate a light painting. That is, the flight trajectory (that is, the predetermined trajectory) to be flown by the first UAV can be drawn based on a light drawing graphic.

In some embodiments, when the first UAV is equipped with the light source and flying based on the first parameter, if the light source starts to illuminate, the light source can be used to generate a light painting when the first UAV is in flight. As such, the controller acquiring the predetermined trajectory may further include using the controller to acquire a first predetermined light painting of the light source, set a painting parameter of the first predetermined light painting, and generate the predetermined trajectory based on the painting parameter. The painting parameter may include at least one of a spatial height, an orientation, or a size of the first predetermined light painting. In some embodiments, the light source may be an indicator light of the first UAV.

In some embodiments, the light painting generated by the first UAV may need to be capture by a corresponding imaging device. To acquire a more complete and undistorted image of the actually generated light painting, the controller may further set an imaging parameter of the imaging device based on the first predetermined light painting. The imaging parameter may be used by the imaging device to capture a light painting generated by the light source based on the imaging parameter set by the controller.

In some embodiments, when the first UAV is equipped with the light source, the first flight parameter may be used by the first UAV to set a control parameter of the light source, such as an illumination time, based on the first flight parameter.

In some embodiments, the imaging device can be fixed on a ground or a building, or the imaging device can be mounted on other UAVs. Regardless of whether the imaging device is fixed on the ground or mounted on other UAVs, the number of imaging devices is not limited in the present disclosure in order to acquire a complete and undistorted light painting. There may be a plurality of imaging devices. Each of the imaging devices may be responsible for a piece of the light painting of the entire light painting, and the pieces of light painting can be combined to obtain the light painting described above.

In some embodiments, when the imaging device is mounted on a second UAV, the second UAV may be set to follow the first UA while in flight. More specifically, the controller may set a second flight parameter of the second UAV based on the first predetermined light painting and transmit the second flight parameter to the second UAV, and the second flight parameter may be used by the second UAV to fly based on the second flight parameter.

In some embodiments, when the imaging device is mounted on the second UAV, the second UAV may be set to a hovering state, such that the acquired light painting can be prevented from being shaken and distorted. The specific orientation of the second UAV in the hovering state may be selected based on the flight area in which the first UAV performs the light painting, which is not limited in the present disclosure.

When the imaging device is mounted on the second UAV, the controller may perform the flight task setting and the flight task planning for the second UAV and the imaging device in the following manner.

In one embodiment, the controller may transmit the imaging parameter and the second flight parameter to the second UAV, respectively, such that the second UAV may set the imaging angle of the imaging device and a control parameter of the imaging device based on the imaging parameter, and set a flight trajectory of the second UAV based on the second flight parameter.

In another embodiment, the controller may transmit the imaging parameter to the second UAV such that the second UAV may set the second flight parameter of the second UAV based on the imaging parameter, and set the imaging angle of the imaging device and the control parameter of the imaging device.

When the imaging device is disposed on the ground, a building, or the second UAV, after the controller sets the imaging parameter of the imaging device based on the first predetermined light painting, the controller may transmit the imaging parameter to the imaging device, and the imaging parameter may be use by the imaging device to set the imaging angle of the imaging device and the control parameter of the imaging device.

In some embodiments, it may be possible to plan a flight of a plurality of UAVs such that the plurality of UAVs can cooperate to complete the flight task. In the present disclosure, the number of the first UAV may be two or more, and the first UAVs may cooperate to complete the entire flight task.

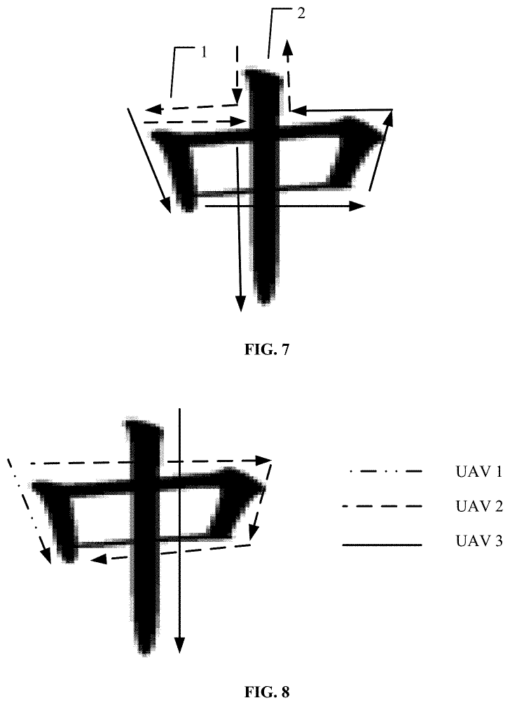

When each of the first UAVs is equipped with a light source and the predetermined trajectory of each of the first UAVs is a part of the predetermined trajectory, the controller may set a corresponding flight parameter for each of the first UAVs based on a predetermined trajectory corresponding to each of the first UAVs, and transmit the set corresponding flight parameter to each of the first UAVs, such that each of the first UAVs may set its flight trajectory based on the receive flight parameter. As such, through the cooperative flight of the plurality of first UAVs, a scene with more complicated flight trajectories and higher flight task requirements, or a scene with complicate light painting can be realized. For example, when the predetermined light painting is the phrase “ [symbol] ”, if a first UAV is used to complete the entire flight task, in order to completely draw the “ [symbol] ” character, the first UAV needs to perform a more complicated flight with multiple turning points. On one hand, when drawing the “ [symbol] ” character, some strokes may be drawn repeatedly, that is, the first UAV may need to re-fly a flight trajectory that was already flown to complete the complete light painting, and it may be difficult to avoid repeated flight of some flight trajectories. FIG. 7 is a diagram illustrating of a flight trajectory of a first UAV according to an embodiment of the present disclosure. As shown in FIG. 7, when only one first UAV is used to drawing the “ [symbol] ” character, the first UAV may fly in the direction of the arrow, and FIG. 7 indicates the repeated flight trajectory with the dotted lines “1” and “2”.

On the other hand, the first UAV may needs to control the illumination time of the light source, that is, when the stroke is terminated or needs to be crossed. For example, when the “ [symbol] ” character in the “ [symbol] ” is drawn, the “ [symbol] ” and “ [symbol] ” characters needs to be drawn across the “ [symbol] ” character. It should be apparent that for one first UAV, to complete the correct drawing of the “ [symbol] ” character, the illumination time of the light source needs to be controlled. For example, when the end point of the “ [symbol] ” is drawn, the light source may be turned off, and when the first UAV flies to the beginning point of the “ [symbol] ” character, the light source may be turned on. The same method may be used on the “ [symbol] ” character and details will not be repeated herein again.

It should be apparent that this control method is more complicated, and the first UAV will spend more time in flight. The control method of the present disclosure can effectively complete the drawing of the light painting or the formation of a designated flight trajectory through the cooperative method of the plurality of first UAVs. Further, the plurality of UAVs may fly and draw in parallel, thereby further improving the efficiency. As shown in FIG. 8, the “ [symbol] ” character is completed cooperatively with a UAV 1, a UAV 2, and a UAV 3. The three UAVs may fly in parallel (e.g., in the direction of the arrows), or the three UAVs may fly in sequence. In principle, the three UAVs may collaborate in a safe range to efficiently complete the drawing of the “ [symbol] ” character.

When a plurality of first UAVs are in a cooperative flight, the controller may respectively transmit an operation instruction to each of the first UAVs, such that each of the first UAVs may sequentially fly based on the flight trajectory set by itself based on the received operation instruction.

Correspondingly, after each of the first UAVs completes the flight, the controller may acquire the flight trajectories of each of the first UAVs, and combine the flight trajectories of the respective first UAVs to obtain eh first flight trajectory.

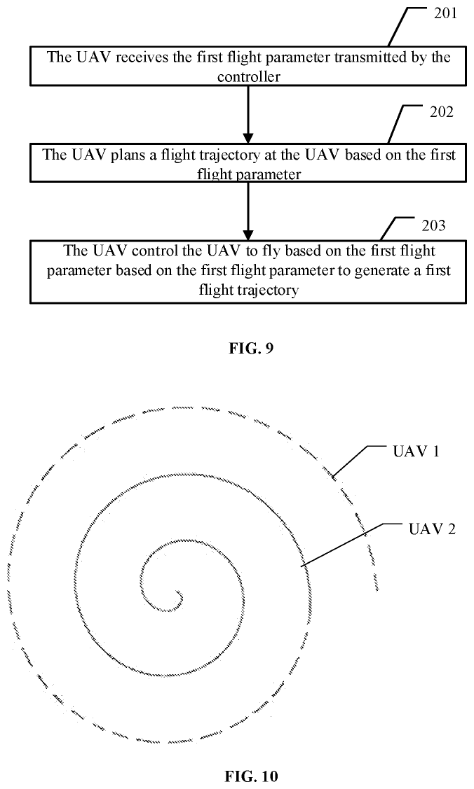

Referring to FIG. 9, the UAV control method of an embodiment of the present disclosure is described from the perspective of the UAV. The control method is described in detail below.

201, the UAV receives the first flight parameter transmitted by the controller.

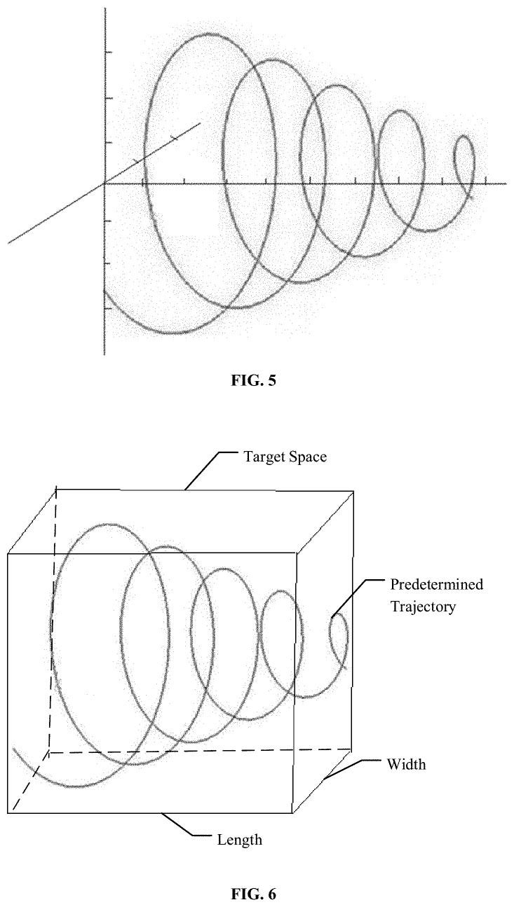

The UAV may be the first UAV or the second UAV described in the embodiments corresponding to FIG. 3 to FIG. 8. Further, the first flight parameter may be converted based on the predetermined trajectory.

202, the UAV plans a flight trajectory at the UAV based on the first flight parameter.

203, the UAV control the UAV to fly based on the first flight parameter to generate a first flight trajectory.

In the embodiment of the present disclosure, the first UAV may fly based on the first flight parameter converted based on the predetermined trajectory and generate the first flight trajectory. It can be seen that since the first flight parameter is acquired based on the predetermined trajectory of the first UAV, it is not necessary to set the flight trajectory of the first UAV by setting the coordinates of each trajectory point to realize the flight parameter acquisition method of the present disclosure, thereby reducing the complexity of setting the flight trajectory.

In some embodiments, the first flight parameter may be set by setting a target space based on the predetermined trajectory using the controller, and generated based on the predetermined trajectory and the target space. In particular, the predetermined trajectory may be within a spatial range of the target space. In some embodiments, the target space may be a three-dimensional body of a regular shape or a three-dimensional body of an irregular shape. For detail, reference may be made to the description of FIG. 6, and details are not repeated herein.

In some embodiments, when the UAV is equipped with the light source, the first flight trajectory may be used to generate a light painting.

In some embodiments, when the UAV is equipped with the light source, the first flight parameter may also be generated by the controller based on a painting parameter of the first predetermined light painting of the light source. That is, the flight trajectory (that is, the predetermined trajectory) to be flown by the first UAV can be drawn based on a light drawing graphic.

In some embodiments, the UAV cooperates with other UAVs to perform the same flight task, that is, each of the cooperating UAV may set a predetermined trajectory. Correspondingly, the predetermined trajectory may correspond to a part of the first predetermined light painting. For example, as shown in FIG. 10, the UAV 1 and the UAV 2 are cooperating to complete a flight task. More specifically, the UAV 1 is responsible for the trajectory corresponding to the broken line portion, and the UAV 2 is responsible for the trajectory of the solid line portion. Each UAV may only need to receive the flight parameter of the part of the flight trajectory transmitted by the controller. Of course, each UAV may also obtain the trajectory of the entire cooperative flight, which is not limited in the present disclosure.

In some embodiments, when an imaging device is disposed on the UAV, the UAV may acquire a second flight parameter and an imaging parameter transmitted by the controller, set an imaging angle of the imaging device and a control parameter of the imaging device based on the imaging parameter, and set a second predetermined trajectory of the UAV based on the second flight parameter. Further, the UAV may fly based on the second flight parameter and control the imaging device to acquire the image of the light painting generated by other UAVs equipped with the light source based on the imaging parameter.

In some embodiments, when an imaging device is disposed on the UAV, the UAV may receive the imaging parameter transmitted by the controller, set the second predetermined trajectory of the UAV based on the imaging parameter, and set the imaging angle of the imaging device and the control parameter of the imaging device. Further, the UAV may fly based on the second flight parameter and control the imaging device to acquire the image of the light painting generated by other UAVs equipped with the light source based on the imaging parameter.

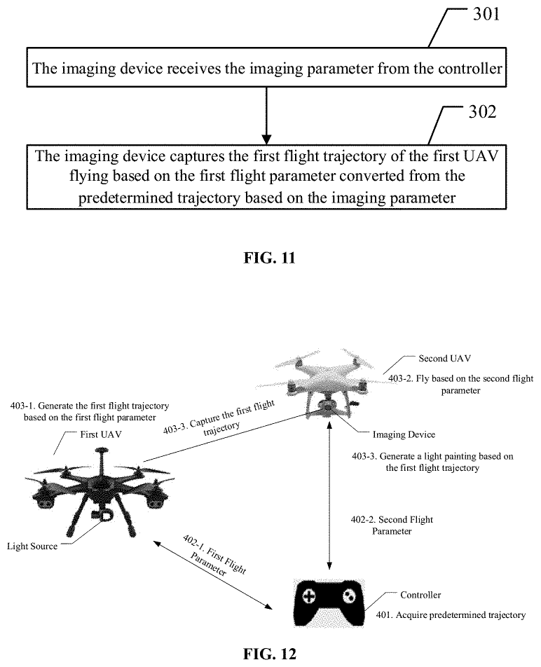

FIG. 11 is flowchart illustrating an imaging device control method according to an embodiment of the present disclosure. The control method is described in detail below.

301, the imaging device receives the imaging parameter from the controller, wherein the imaging parameter is used to configure the imaging device.

302, the imaging device captures the first flight trajectory of the first UAV flying based on the first flight parameter based on the imaging parameter, where the first flight parameter is acquired by converting the predetermined trajectory.

In the embodiment of the present disclosure, since the first flight trajectory acquired by the imaging device is generated by the first UAV based on the first flight parameter by converting the predetermined trajectory, when the imaging device captures the first flight trajectory based on the imaging parameter, the controller does not need to set the flight trajectory of the first UAV by setting the coordinates of each trajectory point to realize the flight parameter acquisition method of the present disclosure, thereby reducing the complexity of setting the flight trajectory.

In some embodiments, when the first UAV is equipped with the light source, the imaging device may further generate a light painting based on the acquired first flight trajectory.

In some embodiments, the imaging device may be disposed on a second UAV.

The present disclosure further provides a UAV system control method. As shown in FIG. 12, the UAV system includes a first UAV and a second UAV, the first UAV includes a light source, and the second UAV includes an imaging device. The UAV system control method is described in detail below.

401, the controller acquires a predetermined trajectory, and a first flight parameter is acquired by converting the predetermined trajectory.

402-1, the first UAV receives the first flight parameter from the controller.

402-2, the second UAV receives a second flight parameter and an imaging parameter from the controller.

403-1, the first UAV controls the first UAV to fly based on the first flight parameter to generate a first flight trajectory.

403-2, the second UAV controls the second UAV to fly based on the second flight parameter, controls the imaging device to acquire the first flight trajectory based on the imaging parameter, and may also generate a light painting based on the first flight trajectory.

403-3, the imaging device acquires the first flight trajectory based on the imaging parameter, and generate the light painting based on the first flight trajectory.

In the embodiment of the present disclosure, after the controller acquires the predetermined trajectory, the predetermined trajectory is converted into the first flight parameter, which is transmitted to the first UAV, such that the first UAV can fly based on the first flight parameter to generate the first flight trajectory. The imaging device disposed on the second UAV acquires the first flight trajectory generated by the first UAV and generates the light painting. It can be seen that since the first flight parameter is acquired based on the predetermined trajectory of the first UAV, it is not necessary to set the flight trajectory of the first UAV by setting the coordinates of each trajectory point to realize the flight parameter acquisition method of the present disclosure, thereby reducing the complexity of setting the flight trajectory.

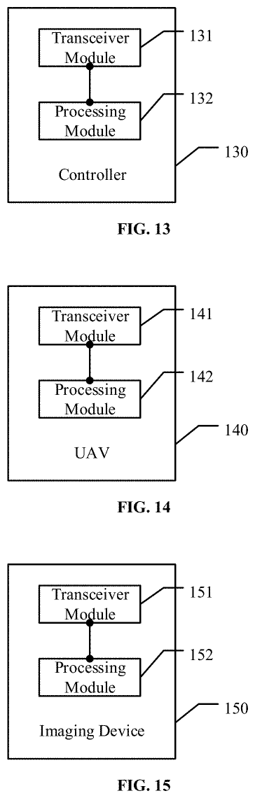

The features of the predetermined trajectory, flight parameter, target space, light painting, flight trajectory, predetermined light painting, imaging parameter, and control parameter described in the previous embodiments are also applicable to the embodiments corresponding to FIG. 13 to FIG. 16 of the present disclosure, and similar features are not described herein again.

The controller and the UAV for performing the UAV control method, the imaging device for performing the imaging device control method, and the UAV system for performing the UAV system control method described above will be respectively described below.

Referring to FIG. 13, a controller 130 includes a transceiver module 131 configured to acquire a predetermined trajectory, a processing module 132 configured to convert the predetermined trajectory acquired by the transceiver module into a first flight parameter, and transmit the first flight parameter to the first UAV through the transceiver module. The first flight parameter is used by the first UAV to fly based on the first flight parameter to generate a first flight trajectory.

In some embodiments, the processing module 132 may be configured to set a target space based on the predetermined trajectory, where the predetermined trajectory may be within a spatial range of the target space; and generate the first flight parameter based on the predetermined trajectory and the target space.

In some embodiments, the target space may be a three-dimensional body of a regular shape or a three-dimensional body of an irregular shape.

In some embodiments, when the first UAV is equipped with a light source, the first flight trajectory may be used to generate a light painting.

In some embodiments, the processing module 132 may be configured to perform one of the following tasks: process the predetermined trajectory input by a user through the controller; or, acquires a first predetermined light painting of the light source, set a painting parameter of the first predetermined light painting, and generate the predetermined trajectory based on the painting parameter. In some embodiments, the painting parameter may include at least one of a spatial height, an orientation, or a size of the first predetermined light painting.

In some embodiments, the processing module 132 may be further configured to set an imaging parameter of the imaging device based on the first predetermined light painting. The imaging parameter may be used by the imaging device to capture a light painting generated by the light source based on the imaging parameter set by the controller.

In some embodiments, when the imaging device is disposed on the second UAV, the processing module 132 may be further configured to set a second flight parameter of the second UAV based on the first predetermined light painting, and transmit the second flight parameter to the second UAV. The second flight parameter may be used by the second UAV to fly based on the second flight parameter.

In some embodiments, the transceiver module 131 may be further configured to transmit the imaging parameter and the second flight parameter to the second UAV, respectively, such that the second UAV may set an imaging angle of the imaging device and a control parameter of the imaging device based on the imaging parameter, and set a flight trajectory of the second UAV based on the second flight parameter.

In some embodiments, when the imaging device is disposed on the second UAV, the transceiver module 131 may be further configured to transmit the imaging parameter to the second UAV, such that the second UAV may set the second flight parameter of the second UAV based on the imaging parameter, and set an imaging angle of the imaging device and a control parameter of the imaging device.

In some embodiments, after the controller sets the imaging parameter of the imaging device based on the first predetermined light painting, the transceiver module 131 may be further configured to transmit the imaging parameter to the imaging device. The imaging parameter may be used by the imaging device to set an imaging angle of the imaging device and a control parameter of the imaging device.

In some embodiments, the number of the first UAV may be two or more, where each of the first UAVs may be equipped with a light source and a predetermined trajectory of each of the first UAVs may be a part of the predetermined trajectory. As such, the processing module 132 may be further configured to set a corresponding flight parameter for each of the first UAVs based on the predetermined trajectory corresponding to each of the first UAVs, and transmit the corresponding set flight parameter to each of the first UAVs by using the transceiver module 131. As such, each of the first UAVs may set its flight trajectory based on the received flight parameter.

In some embodiments, the transceiver module 131 may be further configured to respectively transmit an operation instruction to each of the first UAVs such that each of the first UAVs may sequentially fly based on the flight trajectory set by each of the first UAVs based on the received operation instruction.

In some embodiments, the processing module 132 may be further configured to acquire the flight trajectory of each of the first UAVs through the transceiver module, and combine the flight trajectory of the first UAVs to obtain the first flight trajectory.

In some embodiments, when the first UAV is equipped with the light source, the first flight parameter may be used by the first UAV to set the control parameter of the light source.

In some embodiments, the controller may include at least one of a remote controller, a remote controller with a display, a mobile phone, a tablet, a wristband, a watch, or a pair of flying glasses.

In some embodiments, the light source may be an indication light of the first UAV.

Referring to FIG. 14, a UAV 140 includes a transceiver module 141 configured to receive a first flight parameter transmitted by a controller, where the first flight parameter is converted based on a predetermined trajectory.

The UAV 140 further includes a processing module 142 configured to control the UAV to fly based on the first flight parameter to generate a first flight trajectory.

In some embodiments, the first flight parameter may be set by the controller based on the predetermined trajectory, and generated based on the predetermined trajectory and a target space, where the predetermined trajectory may be within a spatial range of the target space.

In some embodiments, the target space may be a three-dimensional body of a regular shape or a three-dimensional body of an irregular shape.

In some embodiments, when the UAV is equipped with a light source, the first flight trajectory may be used to generate a light painting.

In some embodiments, the first flight parameter may be generated by the controller based on a painting parameter of a first predetermined light painting of the light source.

In some embodiments, when the UAV cooperates with other UAVs to perform the same flight task, the predetermined trajectory may correspond to a part of the first predetermined light painting.

In some embodiments, when the UAV is equipped with an imaging device, the processing module 142 may be further configured to acquire a second flight parameter and an image parameter transmitted by the controller through the transceiver module 141, set an imaging angle of the imaging device and a control parameter of the imaging device based on the imaging parameter, and set a second predetermine trajectory of the UAV based on the second flight parameter. Further, the processing module 142 may be further configured to control the UAV to fly based on the second flight parameter, and control the imaging device to acquire a light painting generated by other UAVs carrying the light source based on the imaging parameter.

In some embodiments, when the UAV is equipped with an imaging device, the processing module 142 may be further configured to receive an imaging parameter transmitted by the controller through the transceiver module 141, set a second predetermined trajectory of the UAV based on the imaging parameter, and set an imaging angle of the imaging device and a control parameter of the imaging device. Further, the processing module 142 may be further configured to control the UAV to fly based on the second flight parameter, and control the imaging device to acquire a light painting generated by other UAVs carrying the light source based on the imaging parameter.

Referring to FIG. 15, an imaging device 150 includes a transceiver module 151 configured to receive an imaging parameter from a controller, where the imaging parameter may be used to configured the imaging device.

The imaging device 150 further includes a processing module 152 configured to acquire a first flight trajectory of a first UAV flying based on the first flight parameter based on the imaging parameter received by the transceiver module, where the first flight parameter may be converted based on a predetermined trajectory.

In some embodiments, the processing module 152 may be further configured to generate a light painting based on the first flight trajectory.

In some embodiments, the imaging device may be disposed on a second UAV.

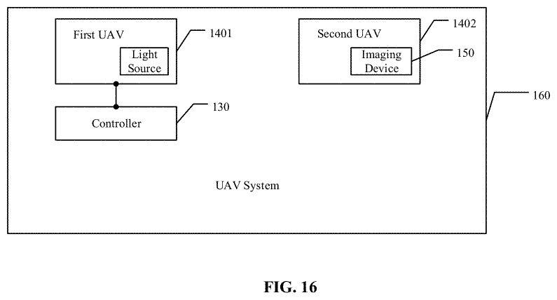

Referring to FIG. 16, a UAV system 160 includes a first UAV 1401 and a second UAV 1402. The first UAV 1401 includes a light source, and a second UAV 1402 includes the imaging device 150.

In some embodiments, the controller 130 may be configured to acquire a predetermined trajectory.

In some embodiments, the first UAV 1401 may be configured to receive a first flight parameter from the controller 130, and control the first UAV 1401 to fly based on the first flight parameter to generate a first flight trajectory. The first flight parameter may be converted based on the predetermined trajectory.

In some embodiments, the second UAV 1402 may be configured to receive a second flight parameter and an imaging parameter from the controller 130, control the second UAV 1402 to fly based on the second flight parameter, control the imaging device 150 to acquire an image of the first flight trajectory based on the imaging parameter, and generate a light painting based on the first flight trajectory.

The present disclosure further provides a computer storage medium storing a program. The program may include some or all of the steps of the UAV control method performed by the controller or the UAV described above, some or all of the steps of the imaging device control method performed by the imaging device described above, and some or all of the steps of the UAV system control method performed by the UAV system described above.

For example, the structure of the controller of the present disclosure includes a processor and a transceiver. The process may be configured to support the controller to perform a corresponding function in the control method described above. The transceiver may be configured to support the communication between the UAV and the imaging device, and transmit information or instructions involved in the control method described above to the controller and the imaging device. The controller may further include a memory for connecting with the processor and retaining the program codes and data needed to perform the UAV control.

In the embodiments described above, the descriptions of the various embodiments are different, and the details that are not provided in a certain embodiment can be referred to the related descriptions of other embodiments.

It can be appreciated by those skilled in the art that for the specific working process of the system, the apparatus, and the module described above, reference can be made to the corresponding process in the foregoing embodiments of the method, and the details description is omitted herein for the convenience and brevity of the description.

In the embodiments of the present disclosure, the disclosed system, apparatus, and method may be implemented in other manners. For example, the embodiments of the apparatus described above are merely illustrative. For example, the division of units/circuits may only be a logical function division, and there may be other ways of dividing the units/circuits. For example, multiple units or circuits may be combined or may be integrated into another system, or some feature may be ignored, or not executed. Further, the coupling or direct coupling or communication connection shown or discussed may include a direct connection or an indirect connection or communication connection through one or more interfaces, devices, or units, which may be electrical, mechanical, or in other form.

The units described as separate components may or may not be physically separate, and a component shown as a unit may or may not be a physical unit. That is, the units may be located in one place or may be distributed over a plurality of network elements. Some or all of the components may be selected according to the actual needs to achieve the object of the present disclosure.

In addition, the functional units in the various embodiments of the present disclosure may be integrated in one processing unit, or each unit may be an individual physically unit, or two or more units may be integrated in one unit. The functional units may be implemented either in hardware or in the form of software functional units. The functional units consistent with the disclosure can be implemented in the form of computer program stored in a non-transitory computer-readable storage medium, which can be sold or used as a standalone product.

All or some of the foregoing embodiments may be implemented through software, hardware, firmware, or any combination thereof. When software is used to implement the embodiments, the foregoing embodiments may be implemented completely or partially in a form of a computer program product.

The computer program product includes one or more computer instructions. When the computer program instructions are loaded or executed on a computer, the procedure or functions according to the embodiments of the present invention are all or partially generated. The computer may be a general-purpose computer, a dedicated computer, a computer network, or other programmable apparatuses. The computer instructions may be stored in a computer-readable storage medium or may be transmitted from a computer-readable storage medium to another computer-readable storage medium. For example, the computer instructions may be transmitted from a web site, computer, server, or data center to another web site, computer, server, or data center in a wired (for example, a coaxial cable, a fiber optic cable, or a digital subscriber line (DSL)) or wireless (for example, infrared, radio, and microwave, or the like) manner. The computer-readable storage medium may be any usable medium accessible by a computer, or a data storage device, such as a server or a data center, integrating one or more usable media. The usable medium may be a magnetic medium (for example, a floppy disk, a hard disk, and a magnetic tape), an optical medium (for example, a digital versatile disc (DVD)), or a semiconductor medium. The semiconductor medium may be a solid-state drive.

The technical solutions provided by the present disclosure are described in detail above. The principle and implementation of the present disclosure are described herein using specific examples. The above description of the embodiments is merely for helping in understanding the method and the core ideas of the present disclosure. At the same time, those skilled in the art can change the specific embodiments and application scopes of the disclosure, based on the idea of the present disclosure. Therefore, the contents of the specification are not intended to limit the scope of the disclosure.

What is claimed is:

1. An unmanned aerial vehicle (UAV) control method, comprising:
acquiring a predetermined trajectory using a controller; and
converting the predetermined trajectory into a first flight parameter using the controller and transmitting the first flight parameter to a first UAV, wherein the first UAV is configured to fly based on the first flight parameter to generate a first flight trajectory.

2. The method of claim 1, wherein the controller converting the predetermined trajectory into the first flight parameter includes:
setting a target space based on the predetermined trajectory, the predetermined trajectory is within a spatial range of the target space; and
generating the first flight parameter based on the predetermined trajectory and the target space.

3. The method of claim 2, wherein the target space may be a three-dimensional body of a regular shape or a three-dimensional body of an irregular shape.

4. The method of claim 2, wherein the first flight trajectory is used to generate a light painting when a light source is disposed on the first UAV.

5. The method of claim 4, wherein the controller acquiring the predetermined trajectory includes one of the following:
the predetermined trajectory being inputted by a user at the controller; or,
the controller acquiring a first predetermined light painting of the light source, setting a painting parameter of the first predetermined light painting, and generating the predetermined trajectory based on the painting parameter, wherein the painting parameter includes one or more of a spatial height, an orientation, and a size of the first predetermined light painting.

6. The method of claim 5, wherein the controller sets an imaging parameter of an imaging device based on the first predetermined light painting, the imaging parameter is used by the imaging device to capture the light painting generated by the light source based on the imaging parameter set by the controller.

7. The method of claim 6, wherein when the imaging device is disposed on a second UAV, the controller sets a second flight parameter of the second UAV based on the first predetermined light painting and transmits the second flight parameter to the second UAV, the second flight parameter is used by the second UAV to fly based on the second flight parameter.

8. The method of claim 7, wherein the controller transmits the imaging parameter and the second flight parameter to the second UAV, respectively, the second UAV is configured to set an imaging angle of the imaging device and a control parameter of the imaging device based on the imaging parameter, and set a flight trajectory of the second UAV based on the second flight parameter.

9. The method of claim 6, wherein when the imaging device is disposed on a second UAV, the controller transmits the imaging parameter to the second UAV, the second UAV is configured to set a second flight parameter of the second UAV based on the imaging parameter, and set an imaging angle of the imaging device and a control parameter of the imaging device.

10. The method of claim 6, wherein after the controller sets the imaging parameter of the imaging device based on the first predetermined light painting, the controller transmits the imaging parameter tot eh imaging device, the imaging device is used by the imaging device to set an imaging angle of the imaging device and a control parameter of the imaging device.

11. The method of claim 6, wherein the number of the first UAV is two or more, each of the first UAVs is equipped with the light source, and a predetermined trajectory of each of the first UAVs is a part of the predetermined trajectory;
the controller sets a corresponding flight parameter for each of the first UAVs based on the predetermined trajectory corresponding to each of the first UAVs, and transmits the set flight parameter to each of the first UAVs to cause each of the first UAVs to fly along a flight trajectory based on the received flight parameter.

12. The method of claim 11, wherein the controller respectively transmits an operation instruction to each of the first UAVs and cause each of the first UAVs to sequentially fly along the flight trajectory based on the received operation instruction.

13. The method of claim 12, wherein the controller acquires the flight trajectory of each of the first UAVs and combine the flight trajectories of the first UAVs to obtain the first flight trajectory.

14. The method of claim 1, wherein when a light source is disposed on the first UAV, the first flight parameter is used by the first UAV to set a control parameter of the light source.

15. The method of claim 1, wherein the controller includes one or more of a remote controller, a remote controller with a display, a mobile phone, a tablet, a wristband, a watch, and a pair of flying glasses.

16. The method of claim 14, wherein the light source is an indication light of the first UAV.

17. A UAV control method, comprising:
receiving a first flight parameter transmitted from a controller at a UAV, the first flight parameter corresponding to a predetermined trajectory; and
controlling the UAV to fly based on the first flight parameter to generate a first flight trajectory.

18. The method of claim 17, wherein the first flight parameter is set by the controller by setting a target space based on the predetermined trajectory, and generated based on the predetermined trajectory and the target space, the predetermined trajectory is within a spatial range of the target space.

19. The method of claim 18, wherein the target space may be a three-dimensional body of a regular shape or a three-dimensional body of an irregular shape.

20. An imaging device control method comprising:
receiving an imaging parameter from a controller for configuring the imaging device; and
capturing, to the imaging parameter, a first flight trajectory of a first UAV flying based on a first flight parameter, the first flight parameter being corresponding to a predetermined trajectory.
